(19) United States
(12) Patent Application Publication
(10) Pub. No.: US 2005/0158592 A1
(43) Pub. Date: Jul. 21, 2005

(54) Battery with traveling disk's function

(75) Inventor: Chi-Feng Lan, Wurih Township (TW)

Correspondence Address: APEX JURIS, PLLC, 13194 EDGEWATER LANE NORTHEAST, SEATTLE, WA, 98125, US

(73) Assignee: Kung-Yuan Sung, Taipei (TW)

(21) Appl. No.: 10/758,438

(22) Filed: Jan. 15, 2004

(51) Int. Cl. H01M 2/00

(52) U.S. Cl. 429/7; 429/61

(57) ABSTRACT

A battery with traveling disk's function stores and retrieves data when connecting to hand-held electrical apparatus, or stores and retrieves data when connecting to electrical apparatus. Thus the battery with traveling disk's function provides the function of storing and retrieving data.

### FIELD OF THE INVENTION

The present invention relates to battery with traveling disk's function adopted for use on portable electrical apparatus and particularly to a battery with traveling disk's function for storing and retrieving data.

### BACKGROUND OF THE INVENTION

In the past, electrical apparatus had to be plugged into a power supply socket to receive electric power. Nowadays most electrical apparatus are portable. These portable electrical apparatus are powered by batteries.

Most batteries merely provide an electric power supply function. Some batteries offer a vibration function to shake the portable electrical apparatus. Aside from this, the battery offers a few other functions.

### SUMMARY OF THE INVENTION

The primary object of the present invention is to provide a battery with traveling disk's function for storing and retrieving data.

The battery with traveling disk's function according to the invention may be selectively connected to portable electrical apparatus or electrical apparatus. The battery with traveling disk's function includes a first connector, a controller, a memory, a transmission interface and a second connector. The first connector may be selectively and electrically connected to a portable electrical apparatus. The controller is connected to the first connector to transmit data. The memory is connected to the controller to store data. The transmission interface is connected to the controller to transmit data. The second connector is connected to the transmission interface to, selectively and electrically, connect to an electrical apparatus. The battery with traveling disk's function thus constructed can store and retrieve data.

Therefore, the battery with traveling disk's function according to the invention can be connected electrically to a portable electrical apparatus. When transmitting data, the first connector is electrically connected to the portable electrical apparatus. The portable electrical apparatus can retrieve data stored in the memory through the controller. On the other hand, when the battery of the invention is electrically connected to the electrical apparatus for data transmission, the second connector is connected electrically to the electrical apparatus so that the electrical apparatus can retrieve the data stored in the memory through the transmission interface and the controller.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the battery with traveling disk's function according to the invention.

FIG. 2 is a schematic view of the structure of the battery with traveling disk's function according to the invention.

### DESCRIPTION OF THE PREFERRED EMBODIMENTS

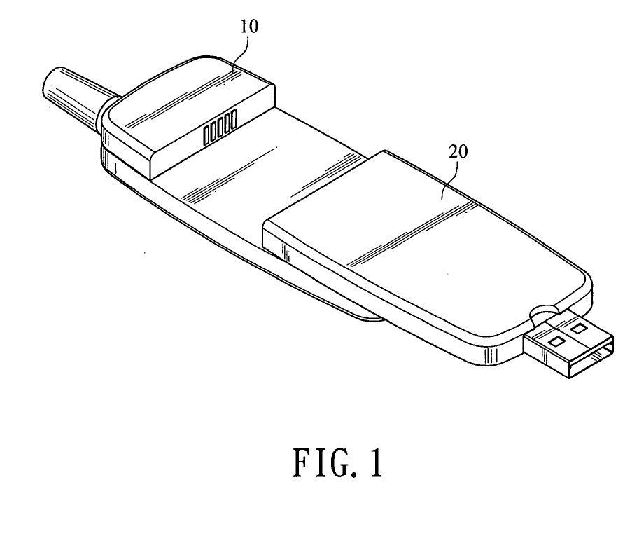

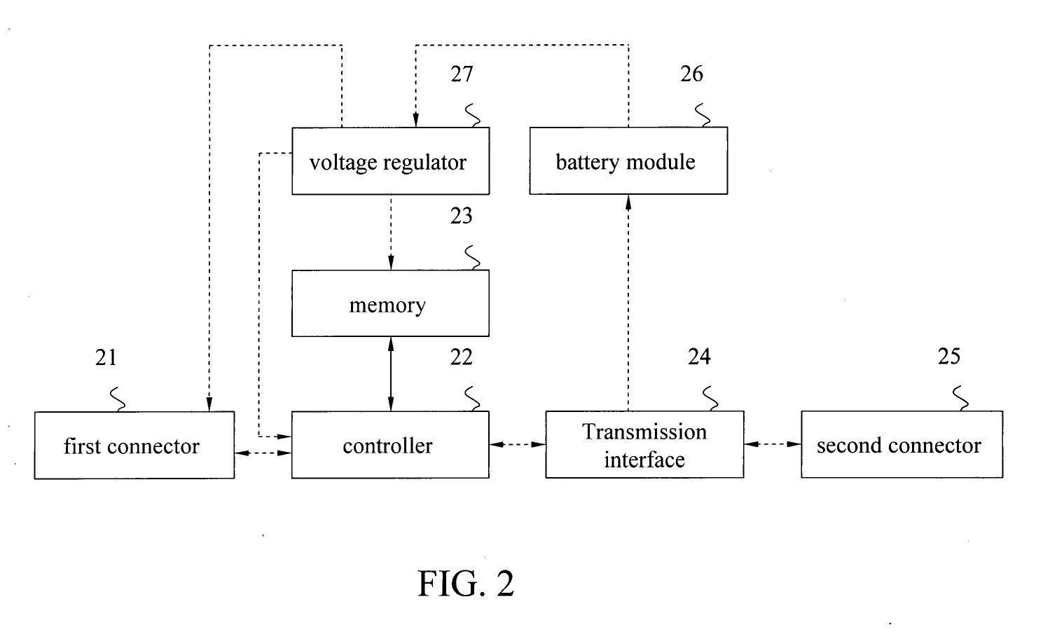

Referring to FIGS. 1 and 2, the battery with traveling disk's function 20 according to the invention aims to be selectively connected to a portable electrical apparatus 10 (a handset is shown in the drawings) or an electrical apparatus (such as a personal computer and notebook computer, not shown in the drawings). The invention includes a first connector 21, a controller 22, a memory 23, a transmission interface 24, a second connector 25, a battery module 26 and a voltage regulator 27.

The techniques for data transmission between the battery with traveling disk's function 20, the portable electrical apparatus 10 and an electrical apparatus are first discussed as follows. The first connector 21 may be selectively and electrically connected to the portable electrical apparatus 10. The controller 22 is connected to the first connector 21 to transmit data. The memory 23 is connected to the controller 22 to store data. The transmission interface 24 is a universal serial bus (USB) connecting to the controller 22 to transmit data. The second connector 25 is connected to the transmission interface 24 to, selectively and electrically, connect to an electrical apparatus.

Hence the battery with traveling disk's function 20 can be connected electrically to the portable electrical apparatus 10. For data transmission, the first connector 21 is connected electrically to the portable electrical apparatus 10, meanwhile, the portable electrical apparatus 10 can retrieve data stored in the memory 23 through the controller 22.

On the other hand, the battery with traveling disk's function 20 according to the invention may be connected electrically to an electrical apparatus. For data transmission, the second connector 25 is connected electrically to the electrical apparatus, meanwhile, the electrical apparatus can retrieve data stored in the memory 23 through the transmission interface 24 and the controller 22.

When the battery with traveling disk's function 20 delivers electric power, the battery module 26 is connected to the first connector 21 to provide electric power for the portable electrical apparatus 10. The voltage regulator 27 is connected to the battery module 26, first connector 21, controller 22 and memory 23 to obtain electric power and regulate the voltage, and delivers electric power to the first connector 21, controller 22 and memory 23. The battery module 26 is connected to the transmission interface 24 so that when the second connector 25 is electrically connected to the electrical apparatus, electric power is delivered, through the transmission interface 24, to the battery module 26 for storing electric power.

Thus when the battery with traveling disk's function 20 is electrically connected to the portable electrical apparatus 10 and delivers electric power, the first connector 21 may be electrically connected to the portable electrical apparatus 10. Meanwhile, the battery module 26 may deliver electric power to the voltage regulator 27, which regulates the voltage and delivers electric power to the first connector 21, controller 22 and memory 23 to provide the electric power required. Of course, because the first connector 21 is electrically connected to the portable electrical apparatus 10, the portable electrical apparatus 10 has electric power needed during operation.

On the other hand, the battery with traveling disk's function 20 is electrically connected to the electrical apparatus. For transmitting electric power, the second connector 25 is electrically connected to the electrical apparatus. Meanwhile, the electrical apparatus delivers electric power to the battery module 26 through the transmission interface 24 for storing electric power.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

1. A battery with traveling disk's function for selectively connecting to a portable electrical apparatus or an electrical apparatus, comprising:
a first connector selectively and electrically connecting to the portable electrical apparatus;
a controller connected to the first connector for transmitting data;
a memory connected to the controller for storing data;
a transmission interface connected to the controller for transmitting data; and
a second connector connected to the transmission interface for selectively and electrically connecting to the portable electrical apparatus such that when the first connector is electrically connected to the portable electrical apparatus the portable electrical apparatus is allowed to retrieve the data in the memory through the controller, and when the second connector is electrically connected to the electrical apparatus the electrical apparatus is allowed to retrieve the data in the memory through the transmission interface and the controller.

2. The battery of claim 1, further including a battery module which is connected to the first connector to provide electric power for the portable electrical apparatus.

3. The battery of claim 2, further including a voltage regulator which is connected to the battery module, the first connector, the controller and the memory to obtain electric power from the battery module and regulate voltage to transmit electric power to the first connector, the controller and the memory.

4. The battery of claim 1, further including a battery module which is connected to the transmission interface to obtain electric power when the second connector is electrically connected to the electrical apparatus, and transmit the electric power through the transmission interface to the battery module for storing.

5. The battery of claim 1, wherein the transmission interface is a universal serial bus (USB).
